(19) United States
(12) Patent Application Publication
(10) Pub. No.: US 2008/0318548 A1
(43) Pub. Date: Dec. 25, 2008

(54) METHOD OF AND SYSTEM FOR STRONG AUTHENTICATION AND DEFENSE AGAINST MAN-IN-THE-MIDDLE ATTACKS

(76) Inventors: JOSE BRAVO, Mamaroneck, NY (US); Jeffery L. Crume, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/765,193

(22) Filed: Jun. 19, 2007

(51) Int. Cl. H04M 1/66

(52) U.S. Cl. 455/411

(57) ABSTRACT

A man-in-the-middle attack resistant method of and system for controlling access of a user to a restricted item receives a request from a user of a first device for access to a restricted item. The system determines the physical location of the first device. The system provides a token to the user and prompts the user to send the token to a recipient using a second device. The system denies the user access to the restricted item if the token is sent from a physical location not matching the physical location of the first device.

### BACKGROUND OF THE INVENTION

1. Technical Field

The present invention relates generally to the field of access control techniques, and more particularly to a method of and system for controlling access to a secure device, service or facility using a strong authentication technique that is resistant to man-in-the-middle attacks.

2. Description of the Related Art

Computers and other devices, as well as secure facilities, services, and financial accounts, often contain proprietary, personal and/or sensitive information. Such information can be compromised if it is accessed by unauthorized individuals. Thus, such devices, facilities, services and accounts, collectively referred to as restricted items, often incorporate security measures, such as database access control mechanisms, to prevent unauthorized users from accessing, obtaining, or altering the information. Various authentication techniques allow users to prove their identities and obtain authorized access to a given restricted item.

U.S. Pat. No. 7,133,662 discloses a strong authentication technique in which a user uses a cellular telephone that has been previously associated with the user to complete the authentication process. The system of the '662 patent provides a token to the user using a first communication channel. The token is typically a string of pseudorandom digits. The first communication channel typically involves an Internet protocol (IP) network such as the Internet. The user is requested to call a specified telephone number and enter the token using the cellular telephone that has been previously associated with the user. The user will obtain access to the restricted item only if the user enters the correct token using the correct cellular telephone.

While the system of the '662 patent provides an excellent authentication technique, the system may be subject to man-in-the-middle attacks. In a man-in-the-middle attack, an imposter's computer interposes itself between an authorized user's computer and a restricted item provider. The man-in-the-middle computer presents to user's computer counterfeit WebPages that look like those of the restricted item provider. The man-in-the-middle computer intercepts IP packets sent between user's computer and the restricted item provider. The man-in-the-middle computer forwards some authentic IP packets and sends some counterfeit packets in order to gain access to restricted items.

### SUMMARY OF THE INVENTION

The present invention provides a man-in-the-middle attack resistant method of and system for controlling access to a restricted item. An embodiment of a system according to the present invention receives a request from a first device for access to a restricted item. The system determines the physical location of the first device. The system provides a token to the first device and prompts the requester to send the token to a recipient using a second device. If the requester is an authentic user, the user will be in close proximity to both the first and second devices. However, a first device of a man-in-the-middle attacker will most likely be at physical location remote from that of the second device of the authentic user. The system grants the requester access to the restricted item if, and only if, the token sent by requester matches token provided to the requester, and the token is sent from a second device previously associated with the requester, and the token is sent from a physical location within a specified distance from the physical location of the first device. In other words, access will be denied if the token is sent from a physical location considered not to be in close proximity to the physical location of the first device.

In embodiments of the present invention, the first device is identified by an Internet Protocol (IP) address. The system determines the physical location of the first device from the IP address. The second device is preferably a cellular telephone that is identified by a telephone number previously associated with the user. The system receives the physical location of the second device with call set-up messaging from a cellular telephone system. The token preferably includes a string of pseudo-random digits.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is a messaging flow diagram illustrating a man-in-the-middle attack on a system of the prior art;

FIG. 3 is a messaging flow diagram according to an embodiment of the present invention with a man-in-the-middle attack;

FIG. 4 illustrates a portion of an embodiment of an authorized user database according to the present invention.

FIG. 5 illustrates a portion of an embodiment of a cellular routing database according to the present invention.

FIG. 6 is a flow chart of an embodiment of access control challenge processing according to the present invention; and,

FIG. 7 is a flow chart or an embodiment of restricted item provider processing according to the present invention.

### DETAILED DESCRIPTION OF THE PREFERRED EMBODIMENT

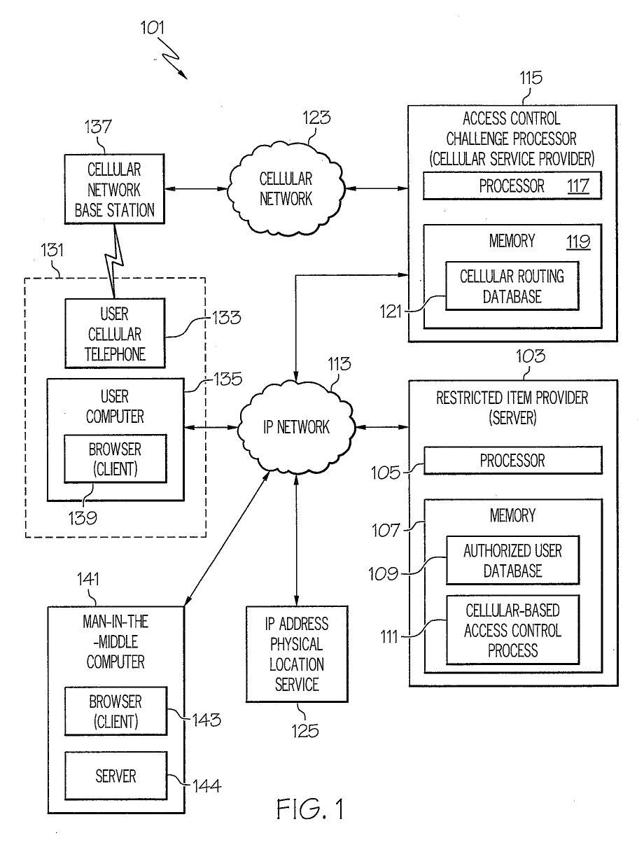

Referring now drawings, and first FIG. 1, an embodiment of a system according to the present invention is designated generally by the numeral 101. System 101 includes a restricted item provider 103. Restricted item provider 103 is a computer system that includes a processor 105. Restricted item provider 103 includes a memory 107 that includes an authorized user database 109 and a cellular-based access control process 111. As will be explained in detail hereinafter, authorized user database 109 includes, for each authorized user, a user identifier, a password, and a cellular telephone identifier. As will also be explained in detail hereinafter, cellular-based access control process 111 includes programming code for controlling access to restricted item provider 103. Restricted item provider 103 is coupled to an Internet protocol (IP) network 113 such as the Internet.

System 101 includes an access control challenge processor 115. Access control challenge processor 115 is a computer system that includes a processor 117. Access control of minister 115 includes a memory 119 that includes a cellular routing database 121. As will be explained in detail hereinafter, cellular routing database 121 includes for each cellular telephone subscriber a cellular telephone number, a telephone serial number, and, optionally, a local coverage area. Access control challenge processor 115 is coupled to IP network 113 and to a cellular network 123. Access control challenge processor 115 and restricted item provider 103 are adapted to communicate with each other through IP network 113. Although restricted item provider 103 and access control challenge processor 115 are described and illustrated as physically separate systems, their respective functionalities may be embodied in a single physical system.

An IP address physical location service 125 is coupled to IP network 113. IP address physical location service 125 is a web-based application that when given an IP address will return the city and/or latitude/longitude where the IP address resides. An example of an IP address physical location service is http://www.geobytes.com/IpLocator.htm. IP address physical location service 125 and restricted item provider 103 are adapted to communicate with each other through IP network 113.

A user system is indicated generally at 131. User system 131 includes a user cellular telephone 133 and a user computer 135. User cellular telephone 133 is adapted to communicate with a cellular telephone base station 137 that is part a cellular network 123. User computer 135 includes a browser 139. User computer 135 is coupled to IP network 113. User computer 135 may be a personal computer owned by the user. However, user computer 135 may also be a third-party computer such as an automatic teller machine (ATM), a point-of-sale terminal, or the like. It is contemplated according to the present invention that user cellular telephone 133 and user computer 135 will be in close physical proximity to each other. Also, with the expansion of capabilities and merging of functions cellular telephones and mobile computers, user cellular telephone 133 and user computer 135 may be implemented in the same device.

A man-in-the-middle computer 141 is coupled to IP network 113. Man-in-the-middle computer 141 includes a browser 143 and a server 144. Man-in-the-middle computer 141 is an imposter that interposes itself between user computer 135 and restricted item provider 103. As is known to those skilled in the art, man-in-the-middle computer 141 presents to user computer 135 counterfeit WebPages that look like those of restricted item provider 103. Server 144 of man-in-the-middle computer 141 intercepts IP packets sent between user computer 135 and restricted item provider 103 in order to defraud user 131 and/or restricted item provider 103. Browser 143 communicates with restricted item provider 103 by impersonating user computer 135. Man-in-the-middle computer 141 may be physically located anywhere. Unless by coincidence, it is unlikely that man-in-the-middle computer 141 will be physically located near user cellular telephone 133.

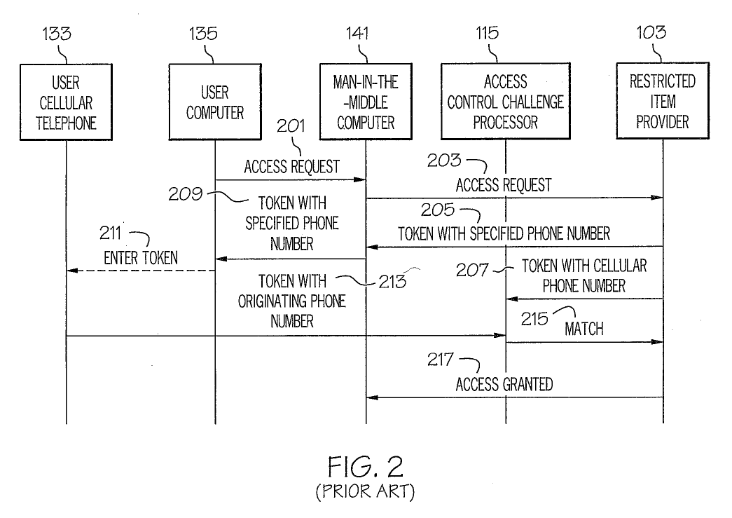

FIG. 2 illustrates the messaging flow according to U.S. Pat. No. 7,133,662. User computer 135 sends an access request 201 intended to be received by restricted item provider 103. However, man-in-the-middle computer 141 intercepts access request 201 and forwards it to restricted item provider 103 as access request 203. Restricted item provider 103 sends an authentication challenge token 205 intended for user computer 135 along with instructions to call a specified telephone number and when prompted enter the token using user cellular telephone 133. The telephone number to call may be specified as a “*8X” number as in common in cellular telephony. Restricted item provider 103 also sends the token with the user cellular telephone number 207 to access control challenge processor 115. The token is preferably a pseudorandom string of digits generated by restricted item provider 103 at the time the token is sent. Man-in-the-middle computer 141 intercepts token message 205 and forwards it to user computer 135 as token message 209. In response to prompting from user computer 135, the user calls the specified number and enters the token as indicated at 211. The token is sent from user cellular telephone 133 to access control challenge processor 115 along with the originating telephone number, as indicated at 213. If the token provided at 213 matches the token provided at 207, access control challenge processor 115 sends a match message 215 to restricted item provider 103. Restricted item provider 103 then sends an access granted message 217 intended for user computer 135. However, access granted message is received by man-in-the-middle computer 141, thereby defeating the strong authentication and giving man-in-the-middle computer 141 access to restricted item provider 103.

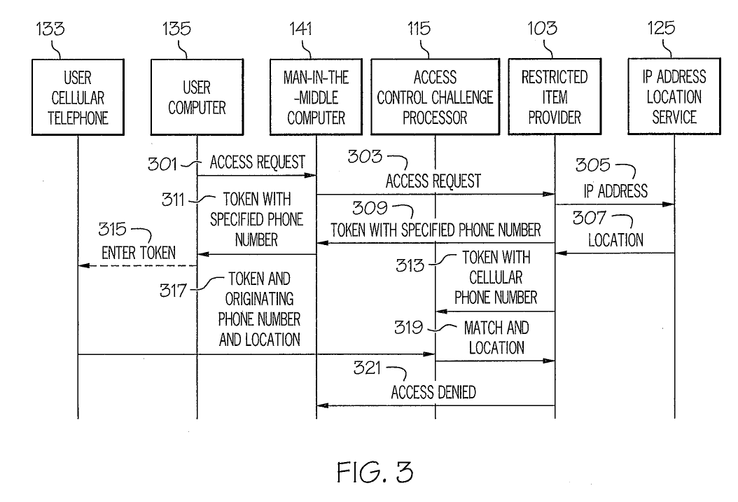

FIG. 3 illustrates message flow according to the present invention. User computer 135 sends an access request 301 intended for restricted item provider 103. However, man-in-the-middle computer 141 intercepts access request 301. Man-in-the-middle computer 141 sends an access request 303 to restricted item provider 103. Restricted item provider 103 sends the IP address 305 from which access request 303 was sent, i.e. man-in-the-middle computer 141, to IP address location service 125. IP address location service 125 returns the physical location 307 of man-in-the-middle computer 141. The physical location may be a city, geographic coordinates, or other location information. The man-in-the-middle computer is unlikely, other than by coincidence, to be physically near user computer 135 or user cellular telephone 133. Restricted item provider 103 sends a token 309 with a specified telephone number intended to be received by user computer 135. However, man-in-the-middle computer 141 intercepts token 309 and forwards the token to user computer 135, as indicated at 311. Restricted item provider 103 also sends the token with the user's cellular telephone number to access control challenge processor 115, as indicated at 313. In response to prompting, the user dials the provided telephone number and enters the token into user cellular telephone 133, as indicated at 315. User cellular telephone 133 sends the token along with originating phone number and location information to access control challenge processor, as indicated at 317. Location information is provided by the cellular telephone system as part of the call set-up messaging. The location provided may be that of the receiving base station. Also, many cellular telephones are GPS enabled such that the location information is the geographic coordinates of the user cellular telephone 133. If the token 317 received matches the token provided at 313, access control challenge processor 115 sends a match message along with location information to restricted item provider 103, as indicated at 319. Since the location of user cellular telephone 133 is not within a specified proximity range, as determined by restricted item provider 103, of the location of man-in-the-middle computer 141, restricted item provider 103 sends an access denied message 321 to man-in-the-middle computer 141 and denies man-in-the-middle computer 141 access.

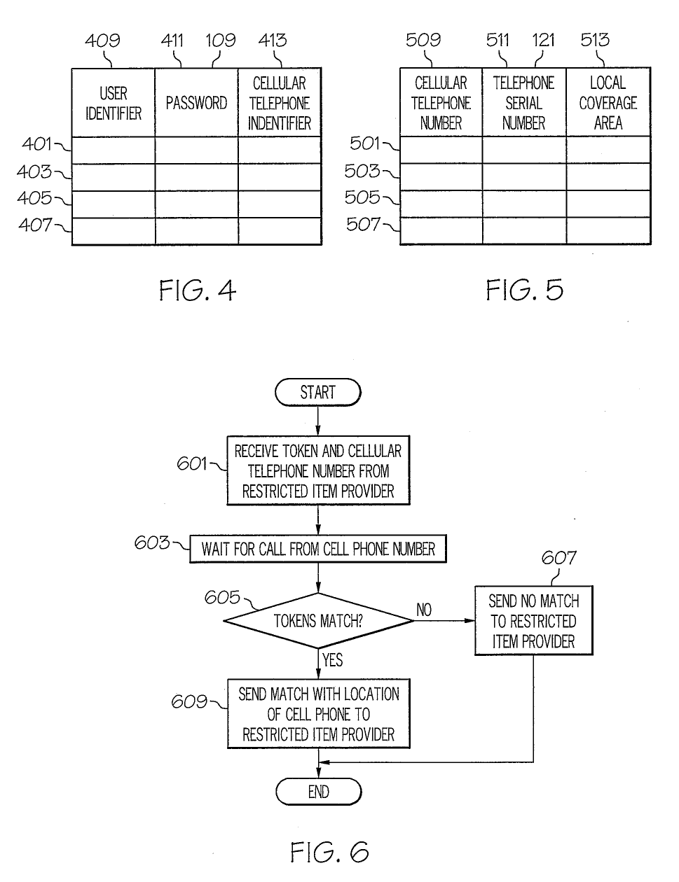

FIG. 4 is a sample table from the authorized user database 109. Generally, authorized user database 109 identifies each authorized user and provides a corresponding cellular telephone identifier that may be utilized to control the access of the user to a restricted item in accordance with the present invention. Authorized user database 109 includes a plurality of records 401-407, each associated with a different authorized user. For each user identified in a user identifier field 409, authorized user database includes the user's password in a field 411, and the corresponding cellular telephone number that has been associated with the user in a field 413.

FIG. 5 is a sample table from cellular routing database 121. Generally, cellular routing database 121 is the same as the routing table found in each cellular site in a cellular telephone network. Cellular routing database 121 indicates how a call should be routed to a given cellular telephone number. As is well known to those skilled in the art, a cellular telephone call is routed to the particular user using the serial number of the cellular phone that has been previously associated with the user. Thus, cellular routing database 121 includes a plurality of records 501-507, each associated with a different cellular telephone user. For each cellular telephone number identified in a field 509, cellular routing database 121 includes the corresponding telephone serial number in a field 511, and optionally, a local coverage area identified in a field 513.

FIG. 6 is a flow chart of an embodiment of access control challenge processor processing according to the present invention. The access control challenge processor receives a token and a cellular telephone number from the restricted item provider, as indicated at block 601. Then, the access control challenge processor waits for a call from the cellular telephone number, as indicated at block 603. When the access control challenge processor receives a call from the cellular telephone number, the access control challenge processor determines, at decision block 605, if the tokens match. If not, the access control challenge processor sends a no match message to the restricted item provider, as indicated at block 607. If the tokens do match, then the access control challenge processor sends a match message with the physical location of the cell phone to the restricted item provider, as indicated at block 609, and processing ends. The access control challenge processor could also simply relay what it received to the restricted item provider and let the restricted item provider determine whether the challenge has been satisfied.

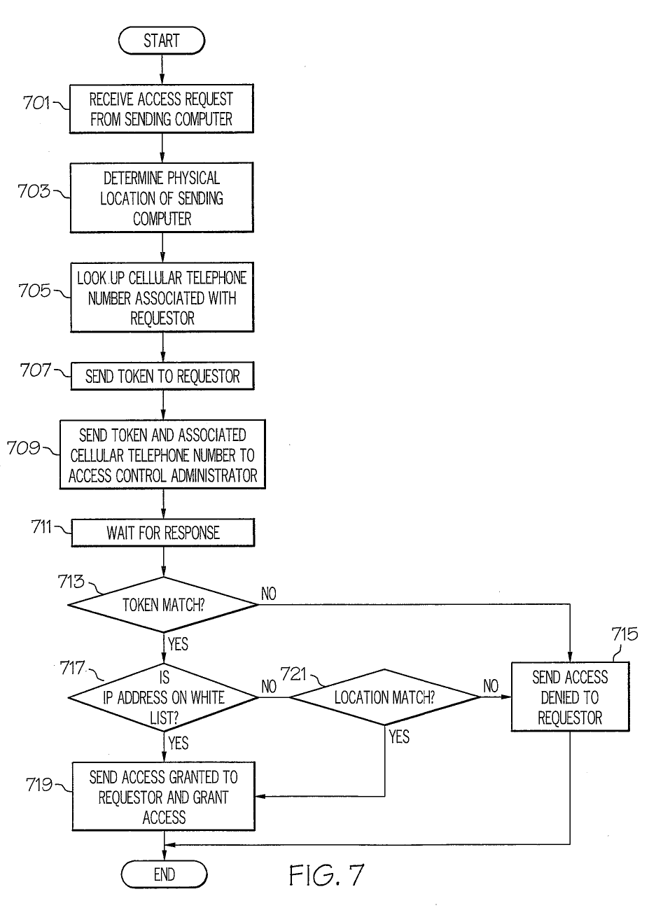

FIG. 7 is a block diagram of an embodiment of restricted item provider processing according to the present invention. The restricted item provider receives an access request from a sending computer, as indicated at block 701. The restricted item provider determines the physical location of the sending computer, as indicated at block 703. The restricted item provider may determine the physical location of the sending computer by sending a query to an IP address physical location service. The restricted item provider looks up the cellular telephone number associated with the requester, as indicated at block 705. Then, the restricted item provider sends a token to the requester as indicated at block 707. The restricted item provider also sends the token and the associated cellular telephone number to the access control challenge processor, as indicated at block 709. Then, the restricted item provider waits for a response from the access control challenge processor, as indicated at block 711. When the restricted item provider receives a response, it determines, at decision block 713, if the response is a token match. If not, the restricted item provider sends an access denied message to the requester, as indicated at block 715, and processing ends. If the restricted item provider receives a token match message, then the restricted item provider determines, at decision block 717, if the IP address of the sending computer is on a “white list” associated with the requestor. A white list is a list of known legitimate IP address, such as those of proxy servers, associated with the requestor. If the IP address of the sending computer is on a white list, the restricted item provider sends an access granted message to the requestor and grants the requestor access to the restricted item, as indicated at block 719, and processing ends. If, as determined at decision block 717, the IP address of the sending computer is not on a white list, the restricted item provider determines, at decision block 721, if the respective locations of the sending computer and the user cellular telephone match, a match being defined as within a specified proximity range of each other. If not, the restricted item provider sends an access denied message to the requester, as indicated at block 715. If the respective locations do match, then the restricted item provider sends an access granted message to the requester and grants access, as indicated at block 719.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method of controlling access to a restricted item, which comprises:
receiving a request for access to a restricted item, said request originating from a first device located at a first physical location;
providing a token to said first device;
prompting a requester to send said token to a recipient using a second device, said second device being located at a second physical location;
denying access to said restricted item if said second physical location is different from said first physical location.

2. The method as claimed in claim 1, including:
denying access to said restricted item if the sent token is different from said provided token.

3. The method as claimed in claim 1, including:
denying access to said restricted item if the token is sent from a second device different from a second device previously associated with said requester.

4. The method as claimed in claim 1, wherein said first device is identified by an Internet Protocol (IP) address and said IP address is associated with said first physical location.

5. The method as claimed in claim 4, including:
determining said first physical location from said IP address.

6. The method as claimed in claim 4, including:
granting access to said restricted item if said IP address is on a white list associated with said requester, and said sent token matches said provided token, and said sent token is sent from a second device previously associated with said requester

7. The method as claimed in claim 1, wherein said second device comprises a cellular telephone.

8. The method as claimed in claim 7, wherein an identifier associated with said cellular phone is previously associated with an authorized user.

9. The method as claimed in claim 7, including;
determining said second location.

10. A system for controlling access to a restricted item, which comprises:
an IP address location service, said address location service being configured to receive an IP address and return a physical location associated with said IP address;
an access control challenge processor, said access control challenge processor being configured to match tokens and determine a physical location of a device sending a token, said device having been previously associated with a user; and,
a restricted item provider in communication with said IP address location service and said access control challenge processor, said restricted item provider including a token generator, and said restricted item provider being configured to match respective physical locations associated with said IP address and said device sending said token.

11. The system as claimed in claim 10, wherein:
said restricted item provider is configured to deny access to a restricted item when said physical location associated with said IP address is outside a specified proximity range of said physical location of said device.

12. The system as claimed in claim 10, wherein:
said restricted item provider is configured to grant access to a restricted item when said IP address is on a white list.

13. The system as claimed in claim 10, wherein said device includes a cellular phone.

14. An article of manufacture for implementing a method of controlling access to a restricted item, which comprises:
a computer readable medium having computer readable code thereon, said compute readable code comprising:
instructions for determining a physical location of a user computer; and,
instructions for determining if a token received is from a device in proximity to said physical location of said user computer, said device having been previously associated with said user.

15. The article of manufacture as claimed in claim 14, wherein said computer readable code further comprises:
instructions for generating said token.

16. The article of manufacture as claimed in claim 14, wherein said instructions for determining said physical location comprise:
instructions for querying an IP address location service.

17. The article of manufacture as claimed in claim 14, wherein said computer readable code further comprises:
instructions for denying access to a restricted item if said token is determined to be received from a device not in proximity to said physical location of said user computer.
